(19) United States
(12) Patent Application Publication
(10) Pub. No.: US 2008/0173715 A1
(43) Pub. Date: Jul. 24, 2008

(54) System and method for electronic voting, using existing ATM network and ATMs associated therewith

(75) Inventor: Barnet L. Liberman, New York, NY (US)

Correspondence Address: COHEN, PONTANI, LIEBERMAN & PAVANE LLP, 551 FIFTH AVENUE, SUITE 1210, NEW YORK, NY, 10176, US

(73) Assignee: Barnet L. Liberman, New York, NY (US)

(21) Appl. No.: 12/011,136

(22) Filed: Jan. 23, 2008

Related U.S. Application Data
(60) Provisional application No. 60/897,193, filed on Jan. 24, 2007.

(51) Int. Cl. G07C 13/00

(52) U.S. Cl. 235/386

(57) ABSTRACT

A system and method for electronic voting. The method includes providing an ATM network that includes ATM machines capable of establishing communication with a voting center, receiving by the one of the ATM machines an electronic ballot, displaying to the voter on the one of the ATM machines the electronic ballot, entering by the voter at least one voting choice into the electronic ballot displayed on the one of the ATM machines, and transmitting by the one the ATM machines the electronic ballot to the voting center.

### RELATED APPLICATIONS

This application claims priority from U.S. Provisional Patent Application Ser. No. 60/897,193 which was filed on Jan. 24, 2007.

### BACKGROUND OF THE INVENTION

1. Field of the Invention

The present invention relates generally to a system and method for electronic voting. More specifically, the present invention relates to an electronic voting system and method that use existing ATM networks.

2. Description of the Related Art

Voting plays a very important role in a democracy society. In such a society, each citizen can cast a vote to elect government officials and political leaders. For example, in the United States, at the federal level, people periodically elect top government officials such as president, senators, and congressmen by voting. Similarly, at the state level, people periodically elect top government officials such as governors, attorney generals, council members, and judicial officials, such as trial-level judges by voting as well. In such a democratic society, voting is preferably conducted in a fair, reliable, accurate, verifiable, efficient, and economically reasonable manner.

Various voting systems are used in the United States.

Paper Ballots

In some parts of the United States, people still vote via paper ballots. A typical paper ballot system employs uniform official paper ballots of various stock weights on which the names of all candidates and other ballot issue choices are printed. On an election day, voters record their choices, in private, by marking the boxes next to the candidates and other ballot issue choices they select, and drop the voted ballots in a sealed ballot box. The voted ballots are thereafter counted manually.

As of 1996, paper ballots were still used by approximately 1.7% of the registered voters in the United States. Paper ballots are typically used as the primary voting system in small communities and rural areas, and quite often for absentee balloting in other jurisdictions. This is because manually counting or recounting a large number of voted ballots is very time-consuming and prone to human errors.

Mechanical Lever Voting Machines

In another parts of the United States, people vote via mechanical lever voting machines. On a typical mechanical lever voting machine, the name of each candidate or ballot issue choice is assigned a particular lever in a rectangular array of levers on the front of the machine. A set of printed strips visible to the voter identifies the lever assignment for each candidate or ballot issue choice. The levels are horizontal in their un-voted, original positions. A voter activates the machine with a main lever that also closes a privacy curtain. The voter then pulls down selected levers to indicate her choices. The voter the makes her choices final (i.e., on the record) and opens the privacy curtain by sliding the main lever back to its original position. The voted levers are automatically returned to their original horizontal positions.

As of the 1996 Presidential election, mechanical lever voting machines were used by approximately 20.7% of the registered voters in the United States.

Mechanical lever voting machines work reasonably well if they are handled properly. However, Mechanical lever voting machines have several shortcomings. First, mechanical lever voting machines are no longer being made in the United States. This sometimes makes the repair and maintenance of such machines problematic and costly. Second, mechanical lever voting machines are heavy and large. As a result, they are not easy to be transported and take up a significant amount of storage space. This increases the transportation, set-up, and storage costs.

Punch Cards

In yet another part of the United States, people vote via punch cards. A typical punch card system employs cards and a small clipboard-sized device for recording votes. On an election day, a voter uses a stylus, a pen-shaped tool, or a machine, to punch holes in the punch card opposite the candidate or ballot issue choice. This operation forms a chad. Once the voting has been completed, the voter either feeds the punch card into a computerized vote-tabulating machine or drops the punch card into a sealed ballot box so that the punch card can be later fed into a computerized vote-tabulating machine.

Two common types of punch cards are the “votomatic” card and the “datavote” card. With the “votomatic” card, the locations at which holes may be punched to indicate votes are each assigned numbers. The number of the hole is the only information printed on the card. The list of the names of the candidates or ballot issue choices and directions for punching the corresponding holes are printed in a separated booklet or are provided somewhere else within the voting booth for the voters to consult. With the “datavote” card, the names of the candidate or ballot issue choices are printed on the card next to the locations of the respective holes to be punched.

As of the 1996 Presidential election, some variation of the punch card system was used by approximately 37.3% of the registered voters in the United States.

Punching a hole on a punch card seems to be a simple task, but various problems may arise from such hole punching. Sometimes voters make incomplete-punched holes. This causes partially-punched chads where one or more corners are still attached, pregnant chads where a hole has been punched through each of the chads but the chads remain attached at the corners, or dimpled chads where there is an indent in each of the chads but no clean hole has been punched.

Mistakes often occur when a computerized vote-tabulating machine tries to read such problematic chads. Moreover, manually counting or recounting such problematic chads is both time-consuming and contentious because such chads can be interpreted in different ways. This was the case in the 2000 Presidential election in the United States, where a majority in the U.S. Electoral College was determined in Florida by the counting of punch card ballots.

Optical Scan Systems

In yet another part of the United States, voting is accomplished via optical scan systems. In a typical optical scan system, on each paper ballot, each of the names of the candidates or ballot issue choices is printed next to an empty rectangle, circle, oval, or an incomplete arrow. Voters record their choices by filling in a selected rectangle, circle, or oval, or by completing a selected arrow, with a black marker. The voted ballots are then counted by an optical scanner (also known as a Mark-Sense voting system) either at the precinct or in a central location. The optical scanner recognizes the darkest mark within a given set on each voted ballot as the correct vote and records it.

As of the 1996 Presidential election, optical scan systems were used by approximately 24.6% of the registered voters in the United States. Optical scanners work reasonably well, but they sometimes fail to correctly “read” voted ballots where the selected rectangles, circles or ovals are not dark enough, are not fully filled in, or where the selected arrows are not fully completed.

Direct Recording Electronic Systems

The most recent configuration in the evolution of voting systems are known as direct recording electronic (DRE). DRE is an electronic implementation of the old mechanical lever voting machines. As with the mechanical lever voting machines, there is no ballot. The possible voting choices are visible to a voter on the front of the machine. The voter directly enters choices into electronic storage with the use of a touch-screen, push buttons, or similar device. An alphabetic keyboard is often provided with the entry device to allow for the possibility of write-in votes. The voter's choices are stored in these machines via a memory cartridge, diskette, or smart card, and added to the choices of all other voters.

In 1996, approximately 7.7% of the registered voters in the United States used some type of direct recording electronic voting system. The 2000 Presidential election led to more usage of direct recording electronic voting systems in the United States.

However, adopting direct recording electronic voting systems requires substantial capital expenses in hardware. In addition, prior to an election, the machines still need to be tested, transported to, and installed in, the various precincts. After the election, the machines need to be removed from the precincts and sent to a storage place.

Moreover, with each of the existing voting systems discussed above, registered voters do not have much freedom as to where they can vote because they have to go to designated precincts to vote. Furthermore, with each of the existing voting systems, a large number of employees of the election boards, temporary workers, and volunteers are still needed at the precincts to check the identification of registered voters and monitor the voting. Another issue is accuracy of absentee ballots, which are not usually counted unless the election is close and then subject to much possible manipulation. This permits absentee balloting to be counted at time of election.

Another element of advantage is the ability of having longer voting hours to encourage greater participation in election process.

Thus, exists a need for a reliable, accurate, and efficient system and method for electronic voting, which does not require any substantial capital investment in hardware.

A further need exists for a system and method for electronic voting that allows votes to select the location from which to vote.

Yet a further need exists for a system and method for electronic voting that substantially reduces the need for the presence and participation of employees of the election boards, temporary workers, and volunteers on an election day.

### SUMMARY OF THE INVENTION

To meet these and other needs, the present application discloses a system and method for electronic voting, which use an existing ATM network and the ATMs associated therewith. The method includes the steps of presenting ballot issue choices in an electronic format to voters via the ATM network and the ATMs, and issuing magnetically encoded voter registration cards and voter registration pin numbers to the voters so that they can vote at the ATMs they choose.

Other features and advantages of the present invention will become apparent from the following detailed description.

In one aspect, the invention relates to a method of electronic voting. The method includes providing an ATM network that includes a plurality of ATM machines capable of establishing communication with a voting center, receiving an electronic ballot by an ATM machine in the plurality of ATM machines; displaying the electronic ballot to a voter on the ATM machine, receiving at least one voting choice entered by the voter into the electronic ballot displayed on the ATM machine, and transmitting the electronic ballot by the ATM machine to the voting center.

In one embodiment, the method includes receiving at the ATM, data from a magnetically encoded, or bar coded voter registration card. The data from the encoded voter registration card is received by the ATM through an electronic card reader in communication with the ATM.

In another embodiment, the method includes receiving at the ATM a voter registration pin number input to the ATM by the voter.

In still another embodiment, the method includes receiving at the ATM voter biometric data.

In yet another embodiment, the method includes displaying to the voter all selected voting choices and providing the voter an option to revise the voting choice before transmitting the electronic ballot to the voting center.

In another embodiment, the method includes generating by the ATM machine a confirmation receipt that includes the date, time, and place of the voting, the name of the voter, the voting choices of the voter, and a code for the election district of the voter. This may be produced in duplicate for the voter to place one copy in an appropriate verification receptacle for later cross check if required.

In still another embodiment, the method includes allowing the voter to confirm each voting choice before entering that voting choice into the electronic ballot.

In another aspect, the invention involves an electronic voting system. The system includes an ATM network that includes a plurality of ATM machines capable of establishing communication with a voting center. Each of the plurality of ATM machines includes means for receiving an electronic ballot from the voting center, means for displaying the electronic ballot for viewing by a voter, means for allowing the voter to enter voting choices on the electronic ballot, and means for transmitting the completed electronic ballot to the voting center.

In one embodiment, each of the plurality of ATM machines includes means for reading a magnetically encoded voter registration card.

In another embodiment, each of the plurality of ATM machines includes means for entering a voter registration pin number.

In still another embodiment, the means for reading a magnetically encoded voter registration card includes a magnetic card reader.

In yet another embodiment, the system includes means for entering biometric data of the voter. The means for entering biometric data of the voter includes at least one of a fingerprint reader, a handprint reader, a microphone, an electronic signature pad, and a face or iris scanner.

In other embodiments, the means for allowing the voter to enter voting choices includes a touch screen and stylus and/or a keypad.

In yet other embodiments, the magnetically encoded voter registration card is time sensitive, and the magnetically encoded voter registration card can be used to access the electronic ballot only once.

In another embodiment, the system includes means for displaying to the voter all selected voting choices and providing the voter an option to revise the voting choices before transmitting the electronic ballot to the voting center.

In still another embodiment, the system includes means for generating a confirmation receipt that includes the date, time, and place of the voting, the name of the voter, the voting choices of the voter, and a code for the election district of the voter.

### BRIEF DESCRIPTION OF THE DRAWINGS

In the drawings, like reference characters denote similar elements throughout the several views.

FIG. 1 is an illustrative block diagram of an electronic voting system, according to one embodiment of the invention.

FIG. 2 is an illustrative flow diagram of the operation of the electronic voting system of FIG. 1.

### DETAILED DESCRIPTION OF THE PRESENTLY PREFERRED EMBODIMENTS

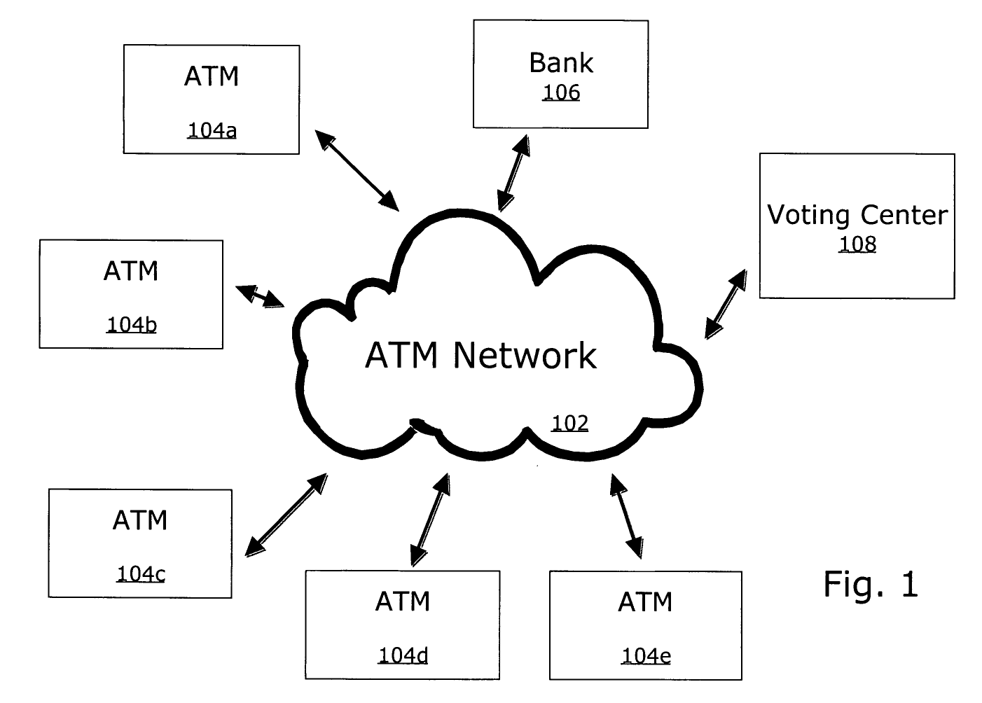

Referring to FIG. 1, in one embodiment, an illustrative block diagram of an electronic voting system 100 is shown. The electronic voting system includes an existing automatic teller machine (ATM) network 102 and at least some of the ATMs 104a-e associated and in communication with the ATM network 102. In this embodiment, the ATM network 102 is also in communication with one or more banking institutions 106 and one or more voting center 108.

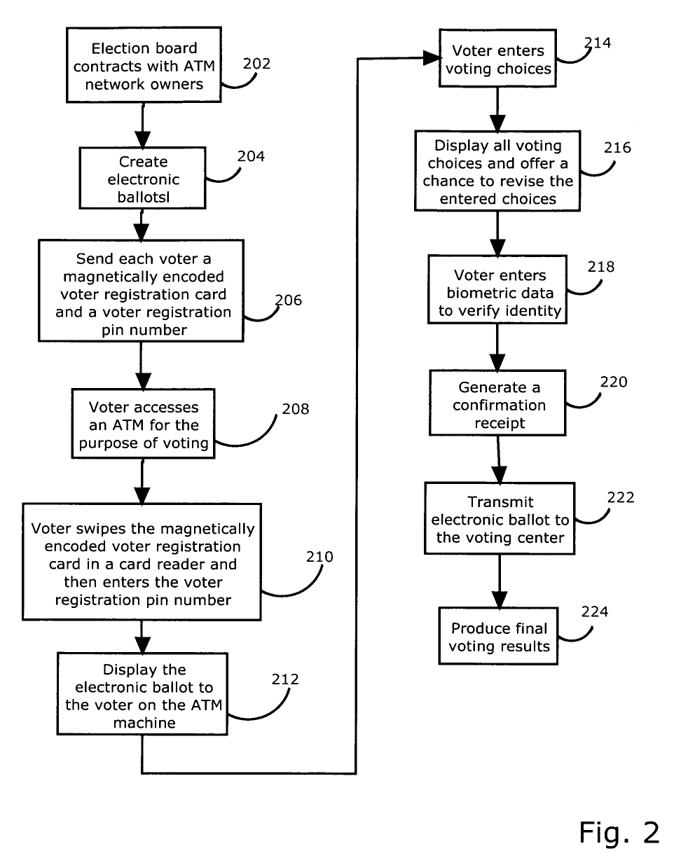

Referring to FIG. 2, in one embodiment, an illustrative flow diagram of the steps for operating the electronic voting system 100 of FIG. 1 is shown. First, before an election, an election board contracts with the operators or servicing company or owners of an existing ATM network 102 so that the election board can use the ATM network 102 and the ATMs 104a-e associated with the network to make ballots. The ballots will include the names of all candidates and other ballot issue choices available to registered voters (step 202). Of course, for each voting district, the election board needs to have the ballots transformed into electronic formats and files (i.e., an electronic ballot) so that the ballots can be transferred through the ATM network and displayed on ATM screens (step 204).

The election board also needs to send each registered voter a magnetically encoded or bar coded voter registration card which is used in conjunction with and a voter registration pin number (step 206). The voter registration pin number is used to identify the electronic ballot of the voting district of the voter.

Preferably, the voter registration card and the voter registration pin number are sent to a voter in separate mails. Alternatively, the registration card may include a phone number so that the recipient of the card can call the phone number to obtain the pin number corresponding to the card, or to otherwise activate the card. A similar procedure is followed by credit card companies when mailing new or replacement credit cards to customers. In one embodiment, the voter registration card carries a picture of the voter. These measures are intended to ensure that only this intended voter can use the voter registration card to vote.

Moreover, the voter registration card is time sensitive (i.e., it can be used to access the electronic ballot during the official voting period such as during a time slot on designated election days only), and can be used to access the electronic ballot only once.

On the designated election days, the voter goes to a conveniently located ATM (e.g., 104a), which is in communication with the ATM network 102 (i.e., near his/her home, office, school, etc.) (step 208). Then the voter swipes his/her voter registration card at the ATM 104a, and enters his/her voter registration pin number (step 210). Thereafter, an electronic ballot of the voter's voting district appears on the screen of the ATM 104a (step 212). The voter then enters his/her voting choices as the screen scrolls (step 214).

Preferably, the electronic ballot is programmed so that the voter has to enter voting choices one by one. In addition, the electronic ballot can be programmed so that additional background information, such as party affiliation and educational and working experience of each candidate, or the history and the underlying purposes of each ballot issue, are available on line through the ATM network as well. Moreover, the electronic ballot can be programmed so that for every choice the voter makes, the ATM will ask her to reconfirm her choice before finally selecting that choice. Of course, it is possible to program the electronic ballot so that the ATM will show the voter all of her choices, and offer her a chance to revise her choices, before transmitting them to the back office of the ATM network (step 216).

Furthermore, it is possible to program the electronic ballot system so that the ATM will ask the voter to provide some form of biometric data before transmitting his/her voting choices (step 218). Such biometric data can include a signature on a screen with stylus verifying technology such as that used with credit/debit card readers, or a voice sample spoken into a microphone. The biometric data can also include, a fingerprint, a handprint, or a face or iris scan, which is obtained using a fingerprint reader, hand print reader, or camera, or other known identification technique, respectively.

Additional hardware needs to be installed on the ATMs for this verifying technology, but the costs should not be substantial. This verifying step should deter and/or reduce voting fraud.

After the completion of the voting, the ATM can generate a confirmation receipt, which can list, among other things, the date, time and place of the voting, the name of the voter, the final choices of the voter, and a code for the election district of the voter (step 220). The confirmation receipt may be generated in duplicate so that an employee of the election board can collect one copy when the voter leaves the location where the ATM is located, or at a later time. Such copies can be used for random auditing and for manual recount if such action is necessary.

Video surveillance, which is widely used in ATM settings, can be used to record the identity of the voter and/or monitor the voting process, which should further deter and/or reduce voting fraud. At the back office of the network, the computer detects and recognizes the card swipe along with the voter registration pin number. Then the computer sends the electronic ballot associated with the voter registration pin number to the screen of the ATM. Final choices of the voter are received and stored in the computer of the ATM system, and tallies are kept (step 222). Then final reports and/or results are produced and provided to the election board (step 224).

As should be apparent from the above discussion, since the system and method of the present invention use an existing ATM network and the ATMs associated with the network, they do not require any substantial capital investment in hardware. They also eliminate the need for setting up voting booths and voting machines prior to an election day. In addition, such system and method provide a voter with many voting location choices so that the voter can vote in a place that is convenient to her. Moreover, such system and method substantially reduce the need of the presence and participation of employees of the election boards, temporary workers and volunteers on an election day. Furthermore, such system and method substantially defer and/or reduce voting fraud.

Thus, while there have shown and described and pointed out fundamental novel features of the present invention as applied to a preferred embodiment thereof, it will be understood that various omissions and other substitutions and modifications/changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed is:

1. A method of electronic voting, comprising:
providing an ATM network comprising a plurality of ATM machines capable of establishing communication with a voting center;
receiving an electronic ballot by an ATM machine in the plurality of ATM machines;
displaying the electronic ballot to a voter on the ATM machine;
receiving at least one voting choice entered by the voter into the electronic ballot displayed on the ATM machine; and
transmitting the electronic ballot by the ATM machine to the voting center.

2. The method of claim 1, further comprising receiving at the ATM, data from a magnetically encoded or bar coded voter registration card.

3. The method of claim 1, further comprising receiving at the ATM a voter registration pin number input to the ATM by the voter.

4. The method of claim 2, wherein the data from the encoded voter registration card is received by the ATM through an electronic card reader in communication with the ATM.

5. The method of claim 1, further comprising receiving at the ATM voter biometric data.

6. The method of claim 1, further comprising displaying to the voter all selected voting choices and providing the voter an option to revise the voting choices before transmitting the electronic ballot to the voting center.

7. The method of claim 1, further comprising generating by the ATM machine a confirmation receipt that includes the date, time, and place of the voting, the name of the voter, the voting choices of the voter, and a code for the election district of the voter.

8. The method of claim 1, further comprising allowing the voter to confirm each voting choice before entering that voting choice into the electronic ballot.

9. An electronic voting system, comprising:
an ATM network comprising a plurality of ATM machines capable of establishing communication with a voting center;
each of the plurality of ATM machines comprising:
means for receiving an electronic ballot from the voting center;
means for displaying the electronic ballot for viewing by a voter;
means for allowing the voter to enter voting choices on the electronic ballot; and
means for transmitting the completed electronic ballot to the voting center.

10. The electronic voting system of claim 9, wherein each of the plurality of ATM machines further comprises means for reading a magnetically encoded voter registration card.

11. The electronic voting system of claim 9, wherein each of the plurality of ATM machines further comprises means for entering a voter registration pin number.

12. The electronic voting system of claim 9, wherein the means for reading a magnetically encoded voter registration card comprises a magnetic card reader.

13. The electronic voting system of claim 9 further comprising means for entering biometric data of the voter.

14. The electronic voting system of claim 13, wherein the means for entering biometric data of the voter comprises at least one of a fingerprint reader, a handprint reader, a microphone, an electronic signature pad, and a face scanner.

15. The electronic voting system of claim 9, wherein the means for allowing the voter to enter voting choices comprises a touch screen and stylus.

16. The electronic voting system of claim 9, wherein the means for allowing the voter to enter voting choices comprises a keypad.

17. The electronic voting system of claim 10, wherein the magnetically encoded voter registration card is time sensitive.

18. The electronic voting system of claim 10, wherein the magnetically encoded voter registration card can be used to access the electronic ballot only once.

19. The electronic voting system of claim 9 further comprising means for displaying to the voter all selected voting choices and providing the voter an option to revise the voting choices before transmitting the electronic ballot to the voting center.

20. The electronic voting system of claim 9 further comprising means for generating a confirmation receipt that includes the date, time, and place of the voting, the name of the voter, the voting choices of the voter, and a code for the election district of the voter.
